(19) United States
(12) Patent Application Publication
(10) Pub. No.: US 2024/0116334 A1
(43) Pub. Date: Apr. 11, 2024

(54) METHOD FOR SPRINKLING A HEAT EXCHANGER

(71) Applicant: MAHLE INTERNATIONAL GMBH, Stuttgart (DE)

(72) Inventors: Dirk ANDRITTER, Kirchheim am Neckar (DE); Richard BRÜMMER, Stuttgart (DE); Klaus HASSDENTEUFEL, Gerlingen (DE); Gunther HENTSCHEL, Uhingen (DE); Thomas STRAUSS, Notzingen (DE)

(21) Appl. No.: 18/378,174

(22) Filed: Oct. 10, 2023

(30) Foreign Application Priority Data
Oct. 11, 2022 (DE) 102022210720.9

(51) Int. Cl. B60H 1/32; F01P 9/02

(52) U.S. Cl. CPC B60H 1/3202; F01P 9/02

(57) ABSTRACT

The invention relates to a method for sprinkling a heat exchanger of a fuel cell vehicle with a fluid. The heat exchanger comprises a sprinkling surface and at least one group with at least one part surface. All part surfaces of all groups together fully represent the sprinkling surface.

In the method, all part surfaces of the group are sprinkled with the fluid within a sprinkling period and not sprinkled within a drying period.

The invention also relates to a sprinkling system for carrying out the method.

### CROSS-REFERENCE TO RELATED APPLICATIONS

This application claims priority from German Patent Application No. DE 10 2022 210 720.9, filed on Oct. 11, 2022, the entirety of which is hereby fully incorporated by reference herein.

The invention relates to a method for sprinkling a heat exchanger of a fuel cell vehicle with a fluid according to the preamble of claim 1. The invention also relates to a sprinkling system for carrying out the method.

Basically, the temperature of the coolant for the engine cooling in a vehicle has to be maintained in a predefined range. For this purpose, the coolant is usually cooled with ambient air in an air-coolant cooler. An improvement of the cooling can take place in different ways. Accordingly, a sprinkling system for a motor vehicle is known for example from DE 196 37 926 A1. There, a cooling liquid is sprayed onto the air-coolant cooler and by way of the subsequent evaporation of the cooling liquid from the air-coolant cooler an additional cooling of the coolant in the air-coolant cooler is achieved. There, the cooling liquid applied during the sprinkling has to evaporate locally. In order to make possible an efficient cooling, the cooling liquid is metered in very small quantities through a diminished overall pressure in the sprinkling system. Disadvantageously, the proportion of the hydrostatic pressure then predominates in the overall pressure, as a result of which an even distribution of the fluid in the sprinkling system is prevented. In a fuel cell vehicle, the temperature of the coolant in comparison with the conventional vehicle with internal combustion engine has to be kept lower and in a narrower range since, even with slight exceeding of the maximum temperature of the coolant, serious damage to the fuel cell has to be expected. If in the sprinkling system the cooling liquid is insufficiently or unevenly applied to the heat exchanger, this can cause serious damage to the fuel cell.

The problem of metering and the even distribution of the cooling liquid accordingly play a particularly major role in the fuel cell vehicle.

The object of the invention therefore is to state for a method for sprinkling a heat exchanger and for a sprinkling system for carrying out the method of the generic type, an improved or at least alternative embodiment, with which the described disadvantages are overcome.

According to the invention, this object is solved through the subject of the independent claims. Advantageous embodiments are subject of the dependent claims.

The present invention is based on the general idea of sequentially applying a fluid to a heat exchanger of a fuel cell vehicle. The method according to the invention is provided for sprinkling a heat exchanger of a fuel cell vehicle with a fluid by means of a sprinkling system. The heat exchanger comprises a sprinkling surface to be sprinkled and at least one group of at least one part surface to be sprinkled. All part surfaces of all groups together fully represent the sprinkling surface of the heat exchanger. According to the invention, all part surfaces of the at least one group are sprinkled with the fluid by means of the sprinkling system in a sprinkling period for a predetermined period of time and, in a drying period, not sprinkled for a predetermined period of time.

In an embodiment, the heat exchanger can comprise the only group with the only part surface, wherein the only part surface then forms the entire sprinkling surface. The heat exchanger can also comprise two or more groups each with the only part surface, wherein all part surfaces together represent the total sprinkling surface. The heat exchanger can also comprise two or more groups each with multiple part surfaces, wherein all part surfaces together represent the complete sprinkling surface. The respective part surface can be exclusively assigned to one of the respective groups.

In the method, all part surfaces of the respective group are sprinkled within the sprinkling period and not sprinkled within the drying period. The sprinkling period and the drying period can alternate periodically. The sprinkling period and the drying period each last for the predetermined period of time, wherein the period of time of the sprinkling period and the drying period can differ from one another. The period of time of the sprinkling period can be for example between 3 and 20 seconds. The period of time of the drying period can be for example between 6 and 60 seconds. The period of time of the sprinkling period and/or the period of time of the drying period can be variable and matched to the current cooling capacity requirement of the heat exchanger. The fluid can be a cooling liquid. In particular water, which develops during the operation of a fuel cell of the fuel cell vehicle, can be utilised as fluid in the method.

In the method, the fluid is discontinuously applied to the heat exchanger or to the part surfaces. within the sprinkling period, the fluid can be applied in a predefined quantity to all part surfaces of the respective group and subsequently evaporate within the drying period. Since the heat exchanger can accumulate and bind the fluid on the sprinkling surface, the heat exchanger can also be briefly over-moistened. within the drying period, the fluid can evaporate from the sprinkling surface of the heat exchanger and because of this the heat exchanger and accordingly the coolant in the heat exchanger be additionally cooled. Since the fluid is applied discontinuously, a larger quantity of the fluid can be applied to all part surfaces of the respective group within the sprinkling period. Accordingly, the total pressure of the sprinkling system is available for the respective part surface, so that the influence of the geodetic pressure plays a subordinate role.

As already explained above, the heat exchanger can comprise at least two groups each with at least one part surface to be sprinkled. In the method, the respective groups of the part surfaces can then be sprinkled by means of the sprinkling system sequentially in time. At a predetermined time, only one of the respective groups of the part surfaces can be within the sprinkling period. The remaining groups of the part surfaces can then be within the drying period. It is not excluded that at a predetermined time all groups can be within the drying period.

The part surfaces of the respective group can be arranged with respect to a height direction of the sprinkling surface that is perpendicular to the width direction, next to one another and alternately to one another. Alternatively or additionally, the part surfaces of the respective groups can be arranged with respect to a width direction of the sprinkling surface that is perpendicular to the height direction, next to one another and alternately to one another. It is also conceivable that the sprinkling surface of the heat exchanger is divided in the length direction and/or in the width direction into multiple part surfaces. In other words, the sprinkling surface of the heat exchanger can be divided in the height direction and/or in the width direction into multiple same-size or different-size part surfaces and the respective part surfaces be assigned to the respective groups. The part surfaces of the respective groups alternate in the height direction and/or width direction, so that two part surfaces of the same group are not arranged adjacently. The sprinkling of the respective groups takes place discontinuously, wherein the respective groups are sequentially within the sprinkling period and within the drying period.

In an installation position of the heat exchanger appropriate for the operation, the sprinkling surface of the heat exchanger can be oriented in particular parallel to the gravitational force of the earth.

The invention also relates to a sprinkling system for carrying out the method described above. The sprinkling system comprises at least one sprinkling tube and at least one distribution tube for conducting the fluid into the at least one sprinkling tube. The at least one sprinkling tube is provided or designed for sprinkling the respective part surface of the respective group. When the respective group is assigned multiple part surfaces, the sprinkling system can comprise for each of the respective part surfaces, at least one sprinkling tube each. The respective sprinkling tube is firmly connected to and fluidically connected via a distribution opening with the respective distribution tube. In addition, the sprinkling system comprises a valve device, wherein the valve device opens the respective distribution opening to the respective sprinkling tube within the sprinkling period for the predetermined period of time and closes the same within the drying period for the predetermined period of time.

By way of the valve device, the respective distribution opening and accordingly the at least one sprinkling tube can be opened or closed. Because of this, the part surface assigned to the respective sprinkling tube can be sprinkled or not sprinkled. Accordingly, the respective part surface and the total sprinkling surface of the heat exchanger can be sprinkled discontinuously.

The valve device can comprise an internal tube received in the distribution tube, wherein the internal tube can be rotatably and/or pivotably and/or displaceably received in the distribution tube. In the internal tube, a control opening each can be formed for the respective sprinkling tube or for sprinkling tubes assigned to the respective part surface. During the rotating and/or pivoting and/or displacing of the internal tube within the distribution tube, the respective control opening can coincide within the sprinkling period, and not coincide within the drying period with the respective distribution opening leading to the respective sprinkling tube or the distribution openings leading to the respective sprinkling tubes. The internal tube can extend over the entire height of the distribution tube and simultaneously open or close multiple sprinkling tubes.

The control opening can be smaller than the distribution opening and because of this a throttle can be formed on the distribution opening. On the throttle, a pressure drop can be additionally created and accordingly the total pressure in the sprinkling system increased. Because of this, the proportion of the hydrostatic pressure in the total pressure can be reduced and the homogeneous and even sprinkling of the heat exchanger achieved.

The valve device can comprise a drive. The drive can be connected so as to interact with the internal tube in such a manner that the internal tube by means of the drive is rotatable and/or pivotable and/or displaceable within the distribution tube. The drive can be for example electric or realised via the fluid pressure in the sprinkling system.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

It shows, in each case schematically

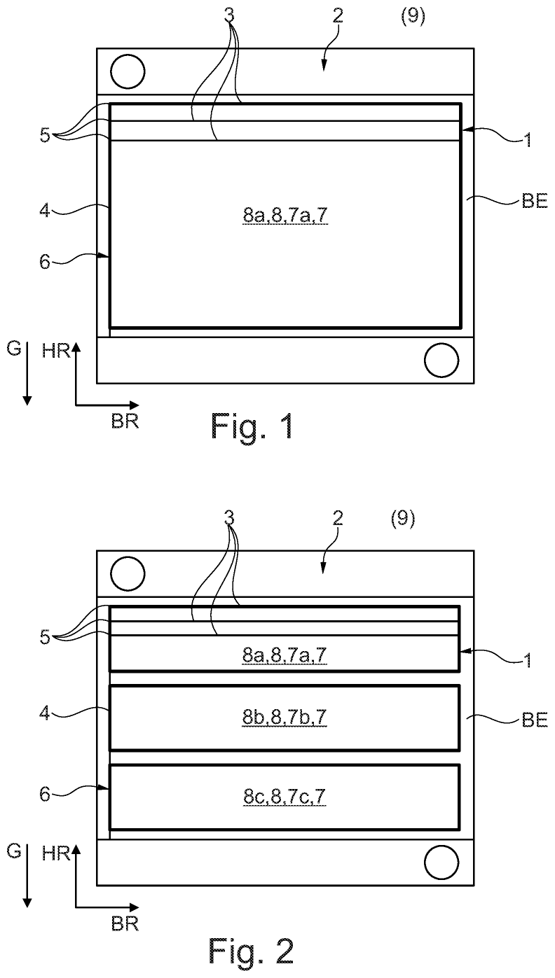

FIGS. 1 to 6 views of a sprinkling system according to the invention on a heat exchanger having a sprinkling surface each divided differently;

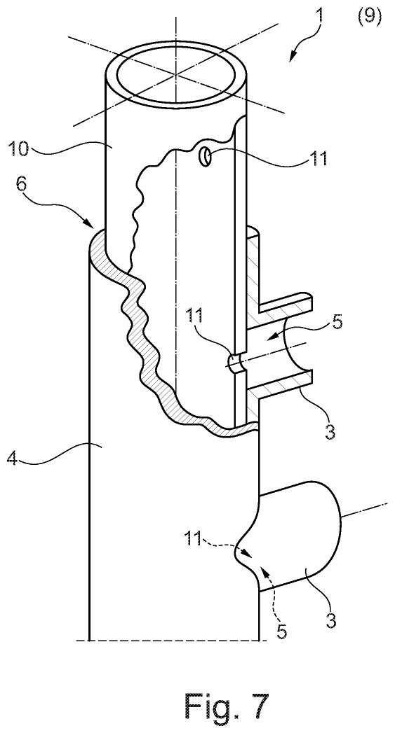

FIG. 7 a partial sectional view of the sprinkling system according to the invention in the region of a valve device;

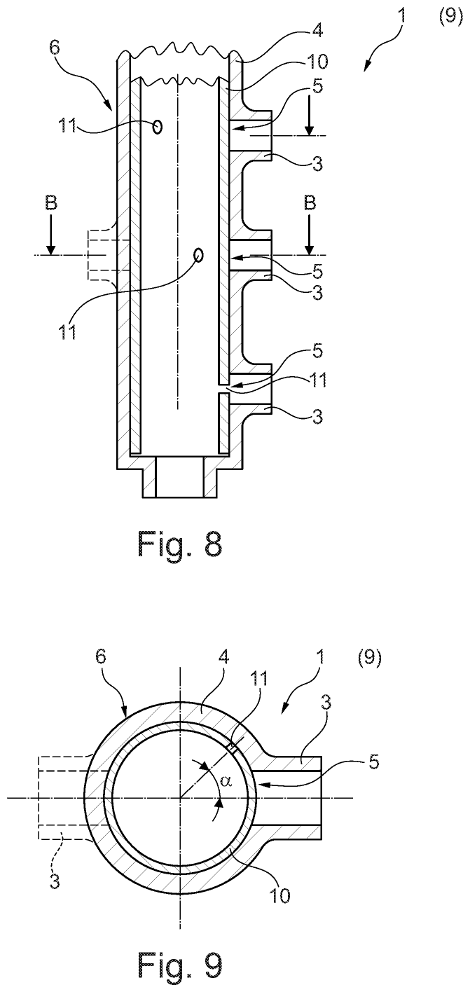

FIG. 8 a sectional view of the sprinkling system according to the invention in the region of the valve device;

FIG. 9 a sectional view of the sprinkling system according to the invention in the region of the valve device in a section plane B-B drawn in in FIG. 8.

FIG. 1 to FIG. 6 show views of a sprinkling system 1 according to the invention on a heat exchanger 2 of a fuel cell vehicle. In FIG. 1 to FIG. 6, the heat exchanger 2 and the sprinkling system 1 are situated in an operationally-appropriate installation position with respect to the gravitational force of the earth G.

The sprinkling system 1 comprises multiple sprinkling tubes 3 and one or more distribution tubes 4. On the one side, the respective sprinkling tube 3 is firmly connected to and fluidically connected via a distribution opening 5 each with the respective distribution tube 4 and on the other side, closed. For the sake of clarity, the sprinkling tubes 3 were only drawn in exemplarily. The respective sprinkling tube 3 and the respective distribution tube 4 are oriented transversely to one another and fluidically connected to one another. In the exemplary embodiments shown here, the distribution tube 4 is oriented parallel to the gravitational force of the earth G and the respective sprinkling tubes 3 are oriented transversely to the gravitational force of the earth G. However, a different arrangement is also conceivable in principle.

In the respective sprinkling tube 3, multiple openings—not shown here—are formed, from which a fluid—for example water—exits onto a sprinkling surface BE of the heat exchanger 2 and evaporates on the same. The sprinkling surface BE of the heat exchanger 2 is divided into at least one group 7 with at least one part surface 8. The respective part surface 8 is assigned at least one of the respective sprinkling tubes 3. The respective sprinkling tube 3 can be assigned to only one of the part surfaces 8. The respective part surface 8, by contrast, can be assigned multiple sprinkling tubes 3.

The sprinkling system 1 according to the invention is designed for carrying out a method 9 according to the invention. In the method 9 according to the invention, the respective groups 7 are discontinuously sprinkled. All part surfaces 8 of the respective group 7 are alternately sprinkled with the fluid within a sprinkling period and not sprinkled within a drying period. When multiple groups 7 are present, these are sprinkled sequentially. At a predetermined time, only a single one of the groups 7 is within the sprinkling period and the remaining groups 7—if present—are within the drying period. It is not excluded that at another predetermined time, all groups 7 can be within the drying period.

For carrying out the method, the sprinkling system 1 can comprise a valve device 6. The valve device 6 is designed in such a manner that the distribution opening 5 leading to the respective sprinkling tube 3 is open within the sprinkling period and closed within the drying period. The distribution opening 5 leading to the respective sprinkling tube 3 can also be closed in a non-water-tight manner, so that the mass flow of the fluid within the drying period is only largely reduced. Accordingly, the fluid can only or for the greatest part flow through the sprinkling tube 3 assigned to the respective part surface 8 within the sprinkling period. In the following, the valve device 6 is explained in more detail by way of FIG. 7 to FIG. 9.

As soon as the sprinkling system 1 comprises a single group 7 having a single part surface 8—as shown here in FIG. 1—a pump of the sprinkling system 1 employed for delivering the fluid can be alternately operated. Because of this, the fluid can, in the same way, flow via the sprinkling tube 3 assigned to the part surface 8 only or for the greatest part within the sprinkling period. In this configuration of the sprinkling system 1, no valve device 6 is necessary. Thus, modulation, here, takes place only via the time and not via the surface.

In FIG. 1, the heat exchanger 2 comprises a single group 7a with a single part surface 8a. Thus, altogether one part surface 8 is present here. Here, the part surface 8a corresponds, in terms of area, to the entire sprinkling surface BE of the heat exchanger 2 to be sprinkled. In the method 9, the part surface 8a of the group 7a is sprinkled discontinuously and is alternately within the sprinkling period and within the drying period. The sprinkling system 1 comprises a single distribution tube 4 and multiple sprinkling tubes 3, which however are assigned to the same part surface 8a. As already described above, no valve device 6 is necessary with this configuration of the sprinkling system 1. The sprinkling period and the drying period can be modulated by alternately operating a pump of the sprinkling system 1 employed for delivering the fluid.

In FIG. 2, the heat exchanger 2 comprises three groups 7a, 7b, 7c each with a single part surface 8a, 8b, 8c. Accordingly, each group 7a, 7b, 7c altogether includes a part surface 8a, 8b, 8c. It is to be understood that the heat exchanger 2 can also comprise more than three groups 7a, 7b, 7c each with more than one part surface 8a, 8b, 8c.

Accordingly, altogether three part surfaces 8 are present here. Together, the part surfaces 8a, 8b, 8c correspond, in terms of area, to the entire sprinkling surface BE of the heat exchanger 2 to be sprinkled. The sprinkling of the heat exchanger 2 takes place according to the method 9 described above, wherein at a predetermined time only one of the groups 7a, 7b, 7c is within the sprinkling period, while the remaining groups 7a, 7b, 7c are within the drying period. The group 7a, 7b, 7c which happens to be within the sprinkling period, alternates periodically. In FIG. 2, the sprinkling surface BE is divided in its height direction H that is parallel to the gravitational force of the earth G, so that the individual part surfaces 8a, 8b, 8c lie on top of one another in the height direction HR or parallel to the gravitational force of the earth G. The sprinkling system 1 comprises a single distribution tube 4 and multiple sprinkling tubes 3, which are assigned to the respective part surfaces 8a, 8b, 8c. It is to be understood that the number and the arrangement of the distribution tubes 4 and of the sprinkling tubes 3 in the sprinkling system 1 can differ from the ones shown here. However, the respective distribution tubes 4 and the respective sprinkling tubes 3 are practically fluidically interconnected in such a manner that the method 9 can be carried out.

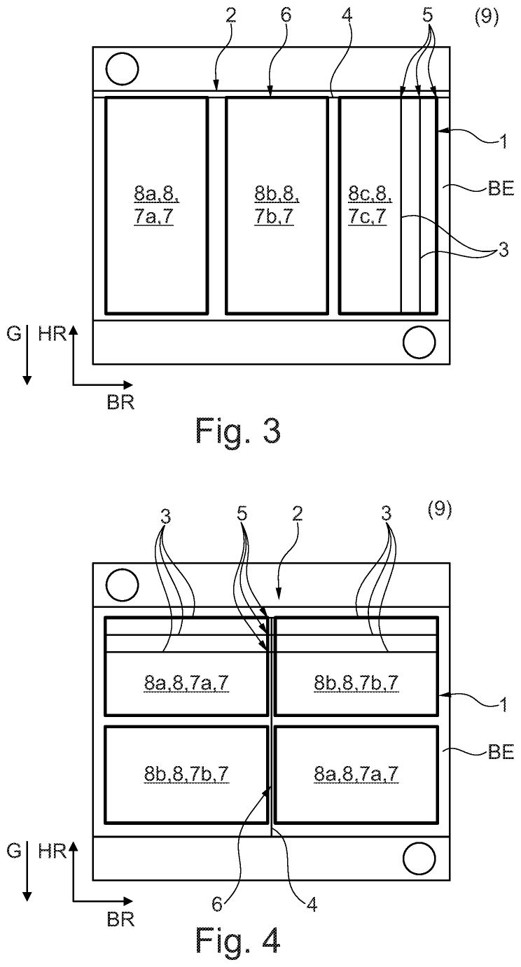

In FIG. 3, the heat exchanger 2 comprises three groups 7a, 7b, 7c each with a single part surface 8a, 8b, 8c. Accordingly, each group 7a, 7b, 7c includes altogether one part surface 8a, 8b, 8c. It is to be understood that the heat exchanger 2 can also comprise fewer or more than three groups 7a, 7b, 7c each with more than one part surface 8a, 8b, 8c. The number of the part surfaces 8a, 8b, 8c assigned to a group 7a, 7b, 7c can vary from group to group. Thus, altogether three part surfaces 8 are present here. Here, too, the part surfaces 8a, 8b, 8c together correspond to the total sprinkling surface BE of the heat exchanger 2 to be sprinkled. The sprinkling takes place according to the method 9 described above, wherein at a predetermined time only one of the groups 7a, 7b, 7c is within the sprinkling period, while the remaining groups 7a, 7b, 7c are within the drying period. The group 7a, 7b, 7c that happens to be within the sprinkling period changes periodically. In FIG. 3, the sprinkling surface BE is divided in its width direction BR perpendicularly to the gravitational force of the earth G, so that the individual part surfaces 8a, 8b, 8c lie next to one another in the width direction BR or transversely to the gravitational force of the earth G. The sprinkling system 1 comprises a single distribution tube 4 and multiple sprinkling tubes 3, which are all assigned to the distribution tube 4. The respective sprinkling tubes 3 are assigned to differing part surfaces 8a, 8b, 8c. It is to be understood that the number and the arrangement of the distribution tubes 4 and of the sprinkling tubes 3 in the sprinkling system 1 can differ from those shown here. However, the respective distribution tubes 4 and the respective sprinkling tubes 3 are practically fluidically interconnected with one another in such a manner that the method 9 can be carried out.

In FIG. 4, the heat exchanger 2 comprises two groups 7a, 7b each with two part surfaces 8a, 8b. Each group 7a, 7b accordingly includes altogether two part surfaces 8a, 8b. Thus, the group 7a comprises two part surfaces 8a and the group 7b comprises two part surfaces 8b. The respective part surfaces 8a, 8b of the respective groups 7a, 7b are not contiguous. Thus, altogether four part surfaces 8 are present here. The respective part surfaces 8a, 8b correspond, together, in terms of area, to the entire sprinkling surface BE of the heat exchanger 2 to be sprinkled and are sprinkled sequentially in time. The sprinkling takes place according to the method 9 described above. It is to be understood that the heat exchanger 2 can also comprise fewer or more than two groups 7a, 7b each with fewer or more than two part surfaces 8a, 8b. The number of the part surfaces 8a, 8b assigned to a group 7a, 7b can vary from group to group. In FIG. 4, the sprinkling surface BE is divided in its height direction HR and in its width direction BR, so that the individual part surfaces 8a, 8b lie on top of one another or next to one another with respect to the gravitational force of the earth G. The respective part surfaces 8a, 8b of the one group 7a, 7b are exclusively adjacent to the respective part surfaces 8a, 8b of the other group 7a, 7b. The sprinkling system 1 comprises a single distribution tube 4 and multiple sprinkling tubes 3, which are assigned to the respective part surfaces 8a, 8b. It is to be understood that the number and the arrangement of the distribution tubes 4 and of the sprinkling tubes 3 in the sprinkling system 1 can differ from the ones shown here. However, the respective distribution tubes 4 and the respective sprinkling tubes 3 are practically fluidically interconnected in such a manner that the method 9 can be carried out.

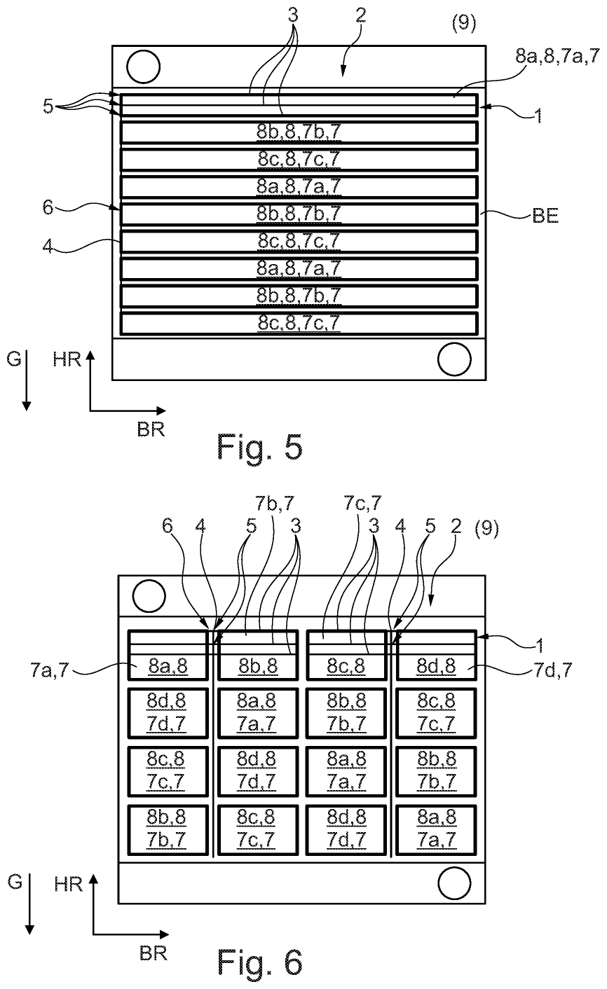

In FIG. 5, the heat exchanger 2 comprises three groups 7a, 7b, 7c each with three part surfaces 8a, 8b, 8c. Accordingly, each group 7a, 7b, 7c altogether includes three part surfaces 8a, 8b, 8c. The group 7a thus comprises three part surfaces 8a, the group 7b comprises three part surfaces 8b and the group 7c comprises three part surfaces 8c. The respective part surfaces 8a, 8b, 8c of the respective group 7a, 7b, 7c are not contiguous. Thus, altogether nine part surfaces 8 are present here. The respective part surfaces 8a, 8b, 8c together correspond, in terms of area, to the entire sprinkling surface BE of the heat exchanger 2 to be sprinkled and are sprinkled sequentially in time. The sprinkling takes place according to the method 9 described above. It is to be understood that the heat exchanger 2 can also comprise fewer or more than three groups 7a, 7b, 7c each with fewer or more than three part surfaces 8a, 8b, 8c. The number of the part surfaces 8a, 8b, 8c assigned to a group 7a, 7b, 7c can vary from group to group. In FIG. 5, the sprinkling surface BE is divided in its height direction HR, so that the individual part surfaces 8a, 8b, 8c lie on top of one another in the height direction or parallel to the gravitational force of the earth G. The sprinkling system 1 comprises a single distribution tube 4 and multiple sprinkling tubes 3, which are assigned to the respective part surfaces 8a, 8b, 8c. It is to be understood that the number and the arrangement of the distribution tubes 4 and of the sprinkling tubes 3 in the sprinkling system 1 can differ from the ones shown here. However, the respective distribution tubes 4 and the respective sprinkling tubes 3 are practically fluidically interconnected in such a manner that the method 9 can be carried out.

In FIG. 6, the heat exchanger comprises four groups 7a, 7b, 7c, 7d each with four part surfaces 8a, 8b, 8c, 8d. Accordingly, each group 7a, 7b, 7c, 7d includes altogether four part surfaces 8a, 8b, 8c, 8d. Thus, the group 7a comprises four part surfaces 8a, the group 7b comprises four part surfaces 8b, the group 7c comprises four part surfaces 8c and the group 7d comprises four part surfaces 8d. The respective part surfaces 8a, 8b, 8c, 8d of the respective group 7a, 7b, 7c, 7d are not contiguous. Thus, altogether sixteen part surfaces 8 are present. The respective part surfaces 8a, 8b, 8c, 8d together correspond, in terms of area, to the entire sprinkling surface BE of the heat exchanger 2 to be sprinkled. The sprinkling takes place according to the method 9 described above.

It is to be understood that the heat exchanger 2 can also comprise fewer or more than four groups 7a, 7b, 7c, 7d each with fewer or more than four part surfaces 8a, 8b, 8c, 8d. The number of the part surfaces 8a, 8b, 8c, 8d assigned to a group 7a, 7b, 7c, 7d can vary from group to group. In FIG. 6, the sprinkling surface BE is divided in its height direction HR and its width direction BR, so that the individual part surfaces 8a, 8b, 8c, 8d lie next to one another in the height direction HR and in the width direction BR. The respective part surfaces 8a, 8b, 8c, 8d of the one group 7a, 7b, 7c, 7d are exclusively adjacent to the respective part surfaces 8a, 8b, 8c, 8d of the other group 7a, 7b, 7c, 7d. The sprinkling system 1 comprises two distribution tubes 4 and multiple sprinkling tubes 3, which are assigned to one of the distribution tubes 4 and the respective part surfaces 8a, 8b, 8c. It is to be understood that the number and the arrangement of the distribution tubes 4 and of the sprinkling tubes 3 in the sprinkling system 1 can differ from the ones shown here. However, the respective distribution tubes 4 and the respective sprinkling tubes 3 are practically fluidically interconnected in such a manner that the method 9 can be carried out.

FIG. 7 shows a partial sectional view of the sprinkling system 1 according to the invention in the region of the valve device 6. The valve device 6 comprises an internal tube 10, which is rotatably received about an axis of rotation RA in the distribution tube 4 by means of an electric drive or purely by means of the fluid pressure. Alternatively, the internal tube 10 can also be pivotably and/or displaceably arranged in the distribution tube 4. In the internal tube 10, a control opening 11 each is formed for the respective sprinkling tube 3, wherein the respective control opening 11, upon rotation of the internal tube 10, closes or opens the respective distribution opening 5. For this purpose, the inner diameter of the distribution tube 4 and the outer diameter of the internal tube 10 are practically matched to one another.

When the respective valve opening 5 is closed, the fluid cannot flow into the respective sprinkling tube 3 and the part surface 8 assigned to the sprinkling tube 3 is not or not substantially sprinkled. When the distribution opening 5 is opened, the fluid can flow into the respective sprinkling tube 3 and the part surface 8 assigned to the sprinkling tube 3 is sprinkled. Upon rotation of the internal tube 10, the respective distribution openings 5 are periodically and sequentially opened and closed, so that a discontinuous sprinkling of the heat exchanger 2 is possible. The internal tube 10 or the control openings 11 of the internal tube 10 are configured in such a manner that at a predetermined time only the distribution openings 5 of the sprinkling tubes 3 are opened, which are assigned to a predetermined group 7 of the part surfaces 8.

FIG. 8 shows a sectional view of the sprinkling system 1 according to the invention in the region of the valve device 6. FIG. 9 shows a sectional view of the sprinkling system 1 according to the invention in the region of the valve device 6 in a section plane B-B drawn in in FIG. 8.

In FIG. 8 it is particularly clearly noticeable that the control openings 11 formed in the internal tube 10 are assigned to the differing groups 7 of the part surfaces 8. In the position of the internal tube 10 shown here, only the lower control opening 11 coincides with the lower distribution opening 5, so that the fluid flows only through the lower sprinkling tube 3 and accordingly only the part surface 8 of the heat exchanger 2 assigned to the lower sprinkling tube 3 is sprinkled. By contrast, the other control openings 11 do not coincide with the other distribution openings 5 so that the fluid does not flow through the assigned sprinkling tubes 3 and accordingly the part surfaces 8 of the heat exchanger 2 assigned to these sprinkling tubes 3 are not sprinkled.

With reference to FIG. 9, the central distribution opening 5 and the central control opening 11 are rotated relative to one another, in the position according to FIG. 8, by an angle α with respect to the axis of rotation RA of the internal tube 10. When the internal tube 10 is now rotated in the clockwise direction by the angle α, the central distribution opening 5 and the central control opening 11 will coincide and the other distribution openings 5 and the other control openings 11 assigned to these will not or no longer coincide. Accordingly, the fluid will only flow through the central sprinkling tube 3 and only the part surface 8 of the heat exchanger 2 assigned to the central sprinkling tube 3 will be sprinkled. The fluid will not flow through the sprinkling tubes 3 assigned to the other distribution openings 5 and accordingly the part surfaces 8 of the heat exchanger 2 assigned to these sprinkling tubes 3 will not be sprinkled.

It is to be understood that at any predetermined time multiple distribution openings 5 can be opened as soon as these are assigned to the single part surface 8 or the multiple part surfaces 8 of the single group 7, it is to be also understood that at any predetermined time all distribution openings 5 can also be closed.

The specification can be best understood with reference to the following Numbered Paragraphs:
Numbered Paragraph 1. A method (9) for sprinkling a heat exchanger (2) of a fuel cell vehicle with a fluid by means of a sprinkling system (1),
wherein the heat exchanger (2) comprises a sprinkling surface (BE) to be sprinkled,
wherein the heat exchanger (2) comprises at least one group (7) with at least one part surface (8) to be sprinkled and all part surfaces (8) of all groups (7) together fully represent the sprinkling surface (BE) of the heat exchanger (2), characterised
in that all part surfaces (8) of the at least one group (7) by means of the sprinkling system (1), within a sprinkling period, are sprinkled with the fluid for a predetermined period of time and in a drying period are not sprinkled for a predetermined period of time.

Numbered Paragraph 2. The method according to Numbered Paragraph 1, characterised
in that the period of time of the sprinkling period amounts to between 3 and 20 seconds and/or the period of time of the drying period between 6 and 60 seconds, and/or
in that the period of time of the sprinkling period and/or the period of time of the drying period varies and is adapted to the current cooling capacity requirement of the heat exchanger (2).

Numbered Paragraph 3. The method according to either one of Numbered Paragraph 1 or 2,
characterised in that the sprinkling period and the drying period alternate periodically.

Numbered Paragraph 4. The method according to any one of the preceding Numbered Paragraphs,
characterised
in that the heat exchanger (2) comprises at least two groups (7) each with at least one part surface (8) to be sprinkled, and
in that the respective groups (7) of the part surfaces (8) are sprinkled by means of the sprinkling system (1) sequentially in time.

Numbered Paragraph 5. The method according to Numbered Paragraph 4, characterised
in that at a predetermined time exclusively one of the respective groups (7) is within the sprinkling period and the remaining groups (7) within the drying period.

Numbered Paragraph 6. The method according to either of Numbered Paragraph 4 or 5, characterised
in that the part surfaces (8) of the respective groups (7) are arranged with respect to a height direction (HR) perpendicularly to the width direction (BR) of the sprinkling surface (BE) next to one another and alternately to one another, and/or
in that the part surfaces (8) of the respective groups (7) are arranged with respect to a width direction (BR) perpendicularly to the height direction (HR) of the sprinkling surface (1), next to one another and alternately to one another.

Numbered Paragraph 7. The method according to any one of the preceding Numbered Paragraphs,
characterised
in that in an operationally-appropriate installation position of the heat exchanger (2), the sprinkling surface (BE) of the heat exchanger (2) is oriented parallel to the gravitational force of the earth (G).

Numbered Paragraph 8. A sprinkling system (1) for carrying out the method (9) according to any one of the preceding Numbered Paragraphs,
wherein the sprinkling system (1) comprises at least one sprinkling tube (3) for sprinkling the at least one part surface (8) of the respective group (7) and at least one distribution tube (4) for conducting the fluid into the at least one sprinkling tube (3),
wherein the respective sprinkling tube (3) is firmly connected to and fluidically connected via a distribution opening (5) with the respective distribution tube (4)
wherein the sprinkling system (1) comprises a valve device (6) which within the sprinkling period opens the respective valve opening (5) to the respective sprinkling tube (3) within the sprinkling period for the predetermined period of time and closes the same within the drying period for the predetermined period of time.

Numbered Paragraph 9. The sprinkling system according to Numbered Paragraph 8, characterised
in that the valve device (6) comprises an internal tube (10) received in the distribution tube (4) and the internal tube (10) is rotatably and/or pivotably and/or displaceably received in the distribution tube (4),
in that in the internal tube (10), for the respective sprinkling tube (3) or for all sprinkling tubes (3) assigned to the respective part surface (8), a control opening (11) each is formed, and
in that the respective control opening (11) upon rotating and/or pivoting and/or displacing of the internal tube (10) within the distribution tube (4) coincides within the sprinkling period and does not coincide within the drying period with the respective valve opening (5) leading to the respective sprinkling tube (3).

Numbered Paragraph 10. The sprinkling system according to Numbered Paragraph 9, characterised
in that the valve device (6) comprises a drive and the drive is connected so as to interact with the internal tube (10) in such a manner that the internal tube (10) is rotatable and/or pivotable and/or displaceable within the distribution tube (4) by means of the drive.

1. A method for sprinkling a heat exchanger of a fuel cell vehicle with a fluid by means of a sprinkling system,
wherein the heat exchanger comprises a sprinkling surface to be sprinkled,
wherein the heat exchanger comprises at least one group with at least one part surface to be sprinkled and all part surfaces of all groups together fully represent the sprinkling surface of the heat exchanger,
wherein all part surfaces of the at least one group by means of the sprinkling system, within a sprinkling period, are sprinkled with the fluid for a predetermined period of time and in a drying period are not sprinkled for a predetermined period of time.

2. The method according to claim 1,
wherein the period of time of the sprinkling period amounts to between 3 and 20 seconds and/or the period of time of the drying period between 6 and 60 seconds, and/or
the period of time of the sprinkling period and/or the period of time of the drying period varies and is adapted to the current cooling capacity requirement of the heat exchanger.

3. The method according to claim 1, wherein
the sprinkling period and the drying period alternate periodically.

4. The method according to claim 1, wherein
the heat exchanger comprises at least two groups each with at least one part surface to be sprinkled, and
the respective groups of the part surfaces are sprinkled by means of the sprinkling system sequentially in time.

5. The method according to claim 4, wherein
at a predetermined time exclusively one of the respective groups is within the sprinkling period and the remaining groups within the drying period.

6. The method according to claim 4 wherein
the part surfaces of the respective groups are arranged with respect to a height direction perpendicularly to the width direction of the sprinkling surface next to one another and alternately to one another, and/or
the part surfaces of the respective groups are arranged with respect to a width direction perpendicularly to the height direction of the sprinkling surface, next to one another and alternately to one another.

7. The method according to claim 1, wherein
in an operationally-appropriate installation position of the heat exchanger, the sprinkling surface of the heat exchanger is oriented parallel to the gravitational force of the earth.

8. A sprinkling system for carrying out the method according to claim 1,
wherein the sprinkling system comprises at least one sprinkling tube for sprinkling the at least one part surface of the respective group and at least one distribution tube for conducting the fluid into the at least one sprinkling tube,
wherein the respective sprinkling tube is firmly connected to and fluidically connected via a distribution opening with the respective distribution tube
wherein the sprinkling system comprises a valve device which within the sprinkling period opens the respective valve opening to the respective sprinkling tube within the sprinkling period for the predetermined period of time and closes the same within the drying period for the predetermined period of time.

9. The sprinkling system according to claim 8, wherein
the valve device comprises an internal tube received in the distribution tube and the internal tube is rotatably and/or pivotably and/or displaceably received in the distribution tube,
in the internal tube, for the respective sprinkling tube or for all sprinkling tubes assigned to the respective part surface, a control opening each is formed, and
the respective control opening upon rotating and/or pivoting and/or displacing of the internal tube within the distribution tube coincides within the sprinkling period and does not coincide within the drying period with the respective valve opening leading to the respective sprinkling tube.

10. The sprinkling system according to claim 9, wherein
the valve device comprises a drive and the drive is connected so as to interact with the internal tube in such a manner that the internal tube is rotatable and/or pivotable and/or displaceable within the distribution tube by means of the drive.
